(19) United States
(12) Patent Application Publication
(10) Pub. No.: US 2004/0180258 A1
(43) Pub. Date: Sep. 16, 2004

(54) Dual material battery terminal

(76) Inventors: Sherman Kau, Davis, CA (US); PuiKei Kau, Hong Kong (CN)

Correspondence Address: DANIEL P. MAGUIRE, 423 E ST., DAVIS, CA, 95616, US

(21) Appl. No.: 10/386,782

(22) Filed: Mar. 12, 2003

(51) Int. Cl. H01M 2/20

(52) U.S. Cl. 429/121; 29/747

(57) ABSTRACT

A dual material battery terminal is disclosed. In one embodiment, this terminal has a post loop made of lead or lead alloy, and a cable mount that is made of copper or copper alloy. The post loop therefore forms a good connection to the battery post, which is also made of lead or lead alloy, and the cable mount forms a good connection with the cables, which also are made of copper. The present invention can also be practiced with other metals such as gold, gold-plated alloy, silver, silver-plated alloy, steel, steel alloy, zinc, zinc alloy, aluminum, and aluminum alloy.

### BACKGROUND OF THE INVENTION

1. Field of the Invention

This invention relates to terminals for batteries.

2. General Background

Many batteries, such as vehicular lead acid batteries, have posts that extend upward from the battery to provide an external electrical connection point. To establish an electrical connection between the battery and the appliance or electrical system that draws power from the battery, terminals are fastened to the posts, and electrical cables are attached to the terminals.

For vehicular applications, these terminals have traditionally been made of lead. Since the posts in vehicular batteries are typically made of lead or lead alloy, lead terminals make a good electrical connection to the battery. However, lead is not an ideal material to form a good connection to the vehicular battery cables, which are typically made of copper. Instead, there is resistance between the lead terminal and the copper cables, and this resistance can result in melting or burning of the cables.

In response to the problems with the use of lead terminals for vehicular batteries, copper and plated copper terminals have recently been developed. These copper terminals form a good, non-resistive connection to the electrical cables, but do not form a good connection to the lead or lead alloy posts. These copper terminals can also damage the lead posts by causing corrosion.

Thus, there is a need for a battery terminal that forms a good electrical and chemical connection to both the battery post and the electrical cables.

### SUMMARY OF THE INVENTION

The present invention is a dual material battery terminal. In one embodiment, it comprises a terminal with a lead or lead alloy post loop, and a copper cable mount. More generally, the present invention is a terminal in which the post loop (or analogous structure) is made of a first material that is chosen for its good conductivity with the post, and the cable mount (or analogous structure) is made of a second material chosen for its good conductivity with the cables.

### BRIEF DESCRIPTION OF THE DRAWINGS

FIG. 1 is a perspective view of a prior art right angle lead acid battery terminal as mounted on a vehicle battery.

FIG. 2 is a perspective view of a prior art straight lead acid battery terminal as mounted on a vehicle battery.

FIG. 3 is a perspective view of a right angle dual material lead acid battery terminal according to an embodiment of the present invention, as mounted on a vehicle battery.

FIG. 4 is a top view of the right angle dual material lead acid battery terminal depicted in FIG. 3.

FIG. 5 is a sectional view of the right angle dual material lead acid battery terminal depicted in FIG. 4, taken along line 5-5 of FIG. 4.

FIG. 6 is a sectional view of the right angle dual material lead acid battery terminal depicted in FIG. 4, taken along line 6-6 of FIG. 4.

FIG. 7 is a cross-sectional side view of a straight dual material lead acid battery terminal according to an embodiment of the present invention.

### DETAILED DESCRIPTION

The present invention is a dual material battery terminal, in which the post loop is made of a first material, and the cable mount is made of a second material. In choosing these materials, the first material will be one that forms a good electrical and electrochemical connection to the post, and the second material will be chosen for its ability to form a good electrical and electrochemical connection to the cables. In one embodiment, the first material is lead or a lead alloy, and the second material is copper or a copper alloy.

The terminal according to the present invention has two portions: (i) a post loop, that encircles the battery's post, and (ii) a cable mount, which connects the terminal to the cables.

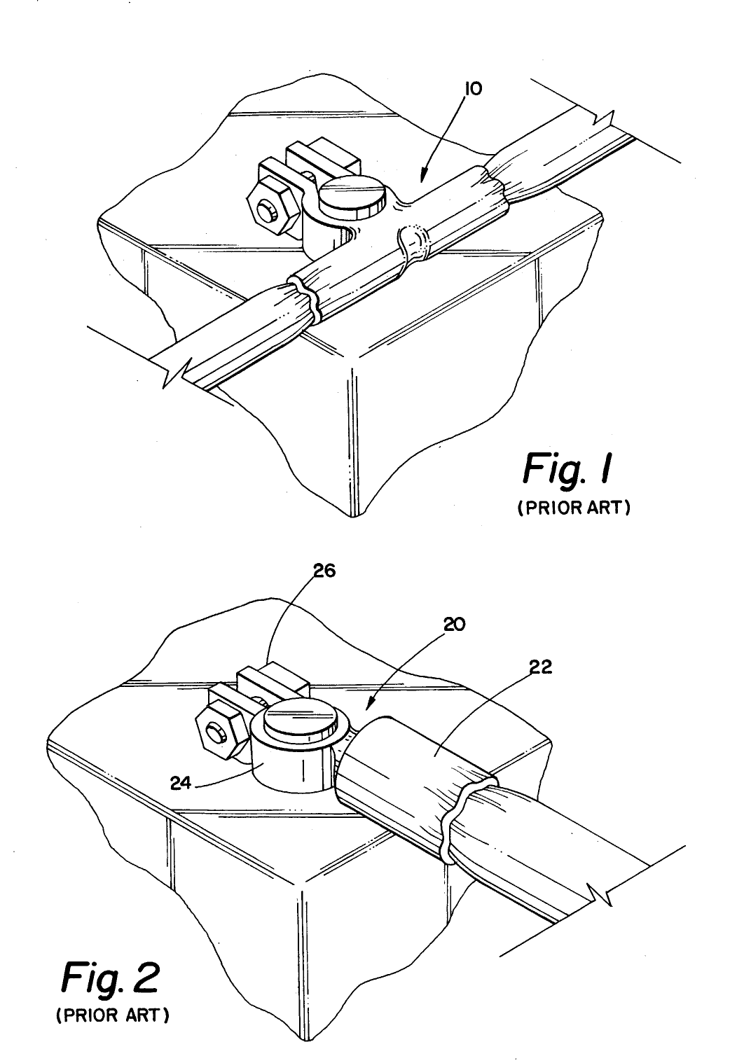

The post loop fits over the battery post, as shown in FIGS. 1, 2, and 3. For purposes of this patent, “post loop” refers generically to any part of the terminal that makes electrical contact with the battery. It includes loops that fit over a battery post, as well as any other sort of means to connect the terminal to the battery. According to the present invention, the post loop should be made of a material that is electrochemically compatible with the post. So, for instance, the post loop can be made of lead or lead alloy, gold, gold-plated alloy, silver, silver-plated alloy, zinc, zinc alloy, copper, copper alloy, aluminum, aluminum alloy and tin. In general, the post loop should be made of a material that is the same as or similar to the post itself.

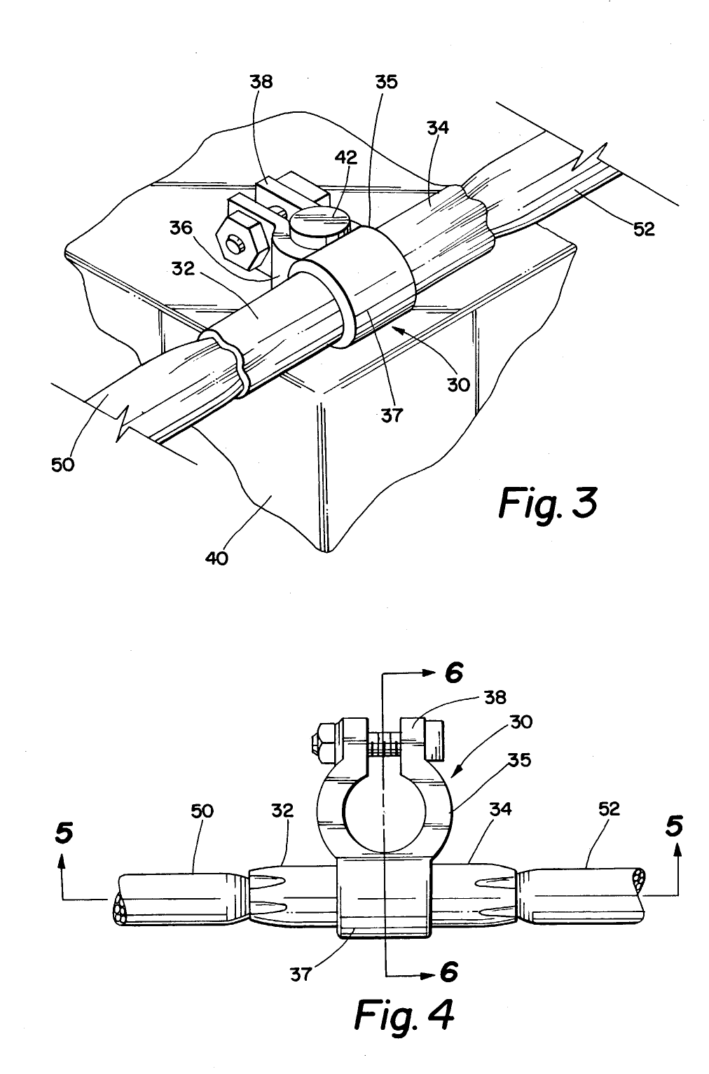

The cable mount is the point of contact between the terminal and the electrical cables. For purposes of this patent, “cable mount” refers generically to the portion of the terminal that makes electrical contact with the cable or cables. In one important embodiment, the cable mount takes the form of a tube, into which the electrical cables are inserted. For instance, as shown in FIG. 3, the terminal 30 has a tube with two portions 32, 34, and the electrical cables are inserted into those tubes. The tube is then crimped until it forms a good mechanical connection with cables.

According to the present invention, the cable mount will be made of a material that forms a good electrical connection to the cables. In one embodiment, copper is used. Other materials that can be used include: gold, gold-plated alloy, silver, silver-plated alloy, steel, steel alloy, zinc, zinc alloy, aluminum, aluminum alloy or tin.

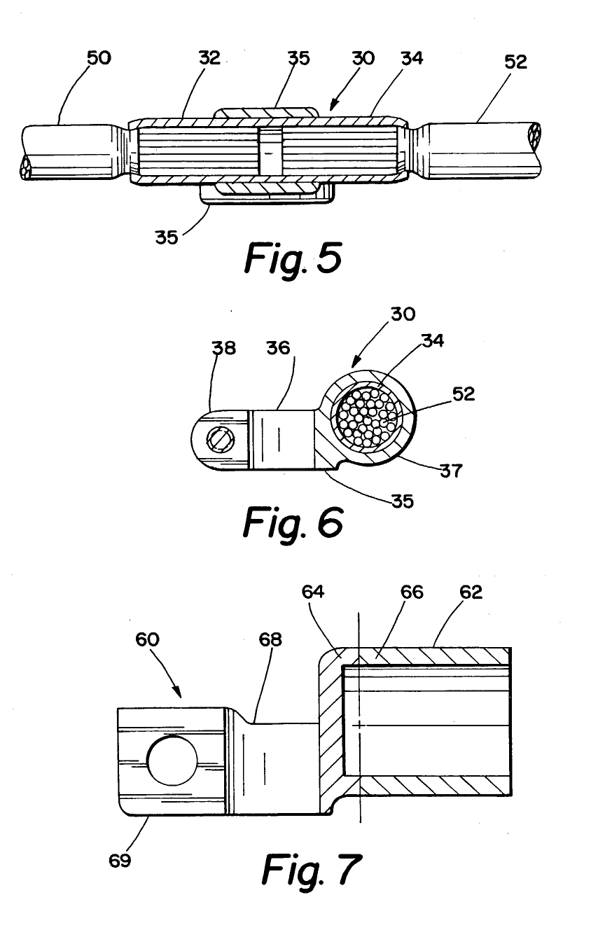

The present invention can be used with many different types of batteries and battery terminals. For instance, FIG. 1 shows a prior art right angle terminal 10, and this terminal can be adapted to a dual material terminal 30, as shown in FIG. 3. In FIG. 3, the terminal 30 has a cable mountain the form of a tube with two portions 32, 34. As shown in FIG. 5, the tube extends through an annular portion 37 of the terminal.

This terminal also has a post mount 35 with a post loop 36 for fitting over the battery post. This post mount 35 and the annular portion 37 of the terminal can be made of lead or other materials including but not limited to gold, gold-plated alloy, silver, silver-plated alloy, steel, steel alloy, zinc, zinc alloy, aluminum, aluminum alloy or tin. Finally, this embodiment has a fastening means 38 for securing the terminal to the post.

Battery cables 52, 54 are inserted into the tubing 32, 34, and then the tube is crimped to secure the cables. See FIG. 6.

In another embodiment, a straight terminal is used. (See FIGS. 2 and 7). In the prior art terminal 20, see FIG. 2, the terminal has a tube 22 for holding the battery cable, and a post loop 24 for fitting over the post. A fastening means 26 is also used to secure the terminal to the post.

Likewise, in the straight terminal embodiment of the present invention as shown in FIG. 7, the terminal has a tube 62, a post loop 68, and a fastening means 69.

However, unlike the prior art, in the present invention the tube 62 has two parts: a first part 64 made of lead or another material that is compatible with the post, and second part 66 that is made of copper or another material that is compatible with the cables. The vertical on FIG. 7 shows the dividing line between the first part and the second part in this particular embodiment.

One method to manufacture the present invention is to pour or inject molten “post loop” material, such as molten lead, into a die that already contains a tube made of the “cable mount” material, such as copper.

One skilled in the art will appreciate that the present invention can be practiced by other than the preferred embodiments, which are presented for purposes of illustration and not of limitation. In particular, the invention revealed in this patent—a dual material battery terminal—can be used in many different types of batteries, and the scope of the claims of this patent is not limited to the particular lead acid batteries emphasized above.

We claim:

1. A terminal for connecting a battery cable to a battery, comprising:
a post loop, said post loop made of a first material; and
a cable mount in electrical contact with said post loop, said cable mount made of a second material, wherein said second material is not the same as said first material.

2. The terminal according to claim 1, wherein said first material comprises lead, and said second material comprises copper.

3. The terminal according to claim 1, wherein said first material comprises a lead alloy, and said second material comprises copper.

4. The terminal according to claim 1, wherein said first material comprises lead, and said second material comprises a copper alloy.

5. The terminal according to claim 1, wherein said first material comprises a lead alloy, and said second material comprises a copper alloy.

6. The terminal according to claim 1, wherein said first material is selected from the group consisting of gold, gold-plated alloy, silver, silver-plated alloy, steel, steel alloy, zinc, zinc alloy, aluminum, aluminum alloy and tin.

7. The terminal according to claim 1, wherein said second material is selected from the group consisting of gold, gold-plated alloy, silver, silver-plated alloy, steel, steel alloy, zinc, zinc alloy, aluminum, aluminum alloy and tin.

8. The terminal according to claim 6, wherein said second material is selected from the group consisting of gold, gold-plated alloy, silver, silver-plated alloy, steel, steel alloy, zinc, zinc alloy, aluminum, aluminum alloy and tin.

9. A method for connecting a battery cable to a battery post, comprising: providing a terminal, said terminal comprising: a post loop, said post loop made of a first material; and a cable mount in electrical contact with said post loop, said cable mount made of a second material, wherein said second material is not the same as said first material; and fitting said post loop on said post.

10. The method according to claim 9, wherein said first material comprises lead, and said second material comprises copper.

11. The method according to claim 9, wherein said first material comprises a lead alloy, and said second material comprises copper.

12. The method according to claim 9, wherein said first material comprises lead, and said second material comprises a copper alloy.

13. The method according to claim 9, wherein said first material comprises a lead alloy, and said second material comprises a copper alloy.

14. The method according to claim 9, wherein said first material is selected from the group consisting of gold, gold-plated alloy, silver, silver-plated alloy, steel, steel alloy, zinc, zinc alloy, aluminum, aluminum alloy and tin.

15. The method according to claim 9, wherein said second material is selected from the group consisting of gold, gold-plated alloy, silver, silver-plated alloy, steel, steel alloy, zinc, zinc alloy, aluminum, aluminum alloy and tin.

16. The method according to claim 14, wherein said second material is selected from the group consisting of gold, gold-plated alloy, silver, silver-plated alloy, steel, steel alloy, zinc, zinc alloy, aluminum, aluminum alloy and tin.
